(19) United States
(12) Patent Application Publication
(10) Pub. No.: US 2015/0193394 A1
(43) Pub. Date: Jul. 9, 2015

(54) SCHEDULING PROCESSING OF RESOURCE REQUESTS TO ENSURE FULFILLMENT OF FOREGROUND REQUESTS

(71) Applicants: Gavin PETERS, Cambridge, MA (US); Matthew E. MENKE, Cambridge, MA (US)

(72) Inventors: Gavin PETERS, Cambridge, MA (US); Matthew E. MENKE, Cambridge, MA (US)

(73) Assignee: Google Inc., Mountain View, CA (US)

(21) Appl. No.: 13/357,859

(22) Filed: Jan. 25, 2012

(51) Int. Cl. G06F 17/22; G06F 15/16

(52) U.S. Cl. CPC G06F 17/2247; G06F 17/227

(57) ABSTRACT

Fulfillment of resource requests obtained, by a browser, from webpages, may include receiving the resource requests, where each of the resource requests are associated with a website. Additionally, the browser may determine a set of the resource requests that are associated with the at least one background window of the web browser; and select the resource requests, the selecting including limiting a quantity of selected resource requests, associated with a particular website, to a first threshold, and limiting a quantity of selected resource requests that are associated with the particular website and that are determined to be in the set of resource requests associated with the at least one background window of the browser, to a second threshold, where the second threshold is less than the first threshold. The browser may transmit the selected plurality of resource requests for fulfillment.

### BACKGROUND

Web browsers are the primary software application through which users access information on the World Wide Web (WWW). A web browser may be defined as a software application for retrieving, presenting, and traversing information resources.

Typically, a web browser may connect to a remotely located web server, to obtain one or more documents that are of interest to the user of the web browser. The documents may be obtained as, for example, hypertext markup language (HTML) documents, which may each contain rendering instructions for the web browser and/or links to additional resources that may be needed to render the documents. The additional resources may be identified by a Uniform Resource Identifier (URI) that may reference a webpage, an image, a video, or another piece of content.

Some web browsers, when initially started, may attempt to restore the state of the web browser when the web browser was previously closed. Restoring the state may include reloading and re-rendering the active documents that were being provided by the browser when the web browser was closed. The delay in reloading and re-rendering several documents at once may decrease a user's perceived browsing experience.

### SUMMARY

One possible implementation may be directed to a method comprising receiving resource requests, associated with webpages, that are to be rendered by a web browser executed by the one or more devices, where the web browser includes a foreground window and at least one background window. The method may further include determining a set of the resource requests that are associated with the at least one background window of the web browser. The method may further include selecting the resource requests, the selecting including limiting a first quantity of selected resource requests associated with the foreground window and the at least one background window, to a first threshold, and limiting a second quantity of selected resource requests that are determined to be in the set of resource requests associated with the at least one background window of the browser, to a second threshold, where the second threshold is less than the first threshold. The method may further include: transmitting the selected resource requests for fulfillment; receiving responses to the transmitted resource requests; and rendering the webpages based on the received responses.

Another possible implementation may be directed to one or more computing devices that include one or more memories to store instructions and one or more processors to execute the instructions. The instructions may be executed to: receive resource requests, associated with webpages, that are to be rendered by a web browser executed by the one or more devices, where the web browser includes a foreground window and at least one background window; determine a set of the resource requests that are associated with the at least one background window of the web browser; select the resource requests, the selecting including limiting a first quantity of selected resource requests associated with the foreground window and the at least one background window, to a first threshold, and limiting a quantity of selected resource requests that are determined to be in the set of resource requests associated with the at least one background window of the browser, to a second threshold, where the second threshold is less than the first threshold; transmit the selected resource requests for fulfillment; receive responses to the transmitted resource requests; and render the webpages based on the received responses.

Another possible implementation may be directed to a computer-readable medium that includes one or more instructions, which when executed by one or more processors, cause the one or more processors to receive resource requests, associated with webpages, that are to be rendered by a web browser executed by the one or more devices, where each of the resource requests are additionally associated with a website, and where the web browser includes a foreground window and at least one background window; one or more instructions, which when executed by one or more processors, cause the one or more processors to determine a set of the resource requests that are associated with the at least one background window of the web browser; one or more instructions, which when executed by one or more processors, cause the one or more processors to select the resource requests, the selecting including limiting a quantity of selected resource requests associated with the foreground window or the at least one background window and associated with a particular website, to a first threshold, and limiting a quantity of selected resource requests that are associated with the particular website and that are determined to be in the set of resource requests associated with the at least one background window of the browser, to a second threshold, where the second threshold is less than the first threshold; one or more instructions, which when executed by one or more processors, cause the one or more processors to transmit the selected resource requests for fulfillment; one or more instructions, which when executed by one or more processors, cause the one or more processors to receive responses to the transmitted resource requests; and one or more instructions, which when executed by one or more processors, cause the one or more processors to render the webpages based on the received responses.

In another possible implementation, a method may include receiving resource requests, included in webpages, that are to be rendered by a web browser, where the web browser includes a foreground window; and determining resource requests that are associated with a foreground window of the web browser. The method may further include selecting resource requests for fulfillment, where one or more of the resource requests that are not associated with the foreground window of the browser are held back, for a particular period, as candidates for selection. The method may further include transmitting the selected ones of the resource requests, to a network, for fulfillment; receiving responses to the transmitted resource requests; and rendering the webpages based on the received responses.

In another possible implementation, one or more computing devices may include one or more memories to store instructions and one or more processors, to execute the instructions. The instructions may be executed to receive a number of resource requests, included in webpages, that are to be rendered by a web browser; determine resource requests that are associated with a foreground window of the web browser; select particular ones of the resource requests for fulfillment, where the resource requests that are not associated with the foreground window of the browser are held back, for a particular period, as candidates for selection; transmit the selected resource requests, to a network, for fulfillment of the resource requests; receive responses to the transmitted resource requests; and render the web pages based on the received responses.

In another possible implementation, a computer-readable medium may include one or more instructions to cause the one or more processors to receive resource requests, included in a webpages, that are to be rendered by a web browser; one or more instructions to cause the one or more processors to determine the resource requests that are associated with a foreground window of the web browser; one or more instructions to cause the one or more processors to select the resource requests for fulfillment, where those of the resource requests that are not associated with the foreground window of the browser are held back, for a particular period, as candidates for selection; one or more instructions to cause the one or more processors to transmit the selected resource requests, to a network, for fulfillment of the resource requests; one or more instructions to cause the one or more processors to receive responses to the transmitted resource requests; and one or more instructions to cause the one or more processors to render the plurality of webpages based on the received responses.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating an example of an interface provided by a web browser;

FIG. 2 is a diagram of an example environment in which techniques described herein may be implemented;

FIG. 3 is a diagram of an example of a generic computing device and a generic mobile computing device, which may be used with the techniques described here;

FIG. 4 is a diagram of example functional components relating to the scheduling of resource requests for fulfillment over a network;

FIG. 5 is a diagram of example functional components illustrating additional details of the resource scheduler and per-site queues, as shown in FIG. 4;

FIG. 6 is a flow chart illustrating an example process for rendering webpages;

FIG. 7 is a diagram of example functional components relating to the scheduling of resource requests for fulfillment; and

FIG. 8 is a flow chart illustrating an example process for rendering webpages.

### DETAILED DESCRIPTION

The following detailed description refers to the accompanying drawings. The same reference numbers in different drawings may identify the same or similar elements.

### Overview

A web browser may provide multiple tabs, where each tab may provide a window through which a webpage may be presented. Typically, at any given time, one of the tabs is the active tab, in which the webpage provided in the window of the active tab is visible to a user. Webpages provided in the window of the non-active tabs may be webpages that are assembled by the web browser, but may not be visible to the user until the user changes the active tab.

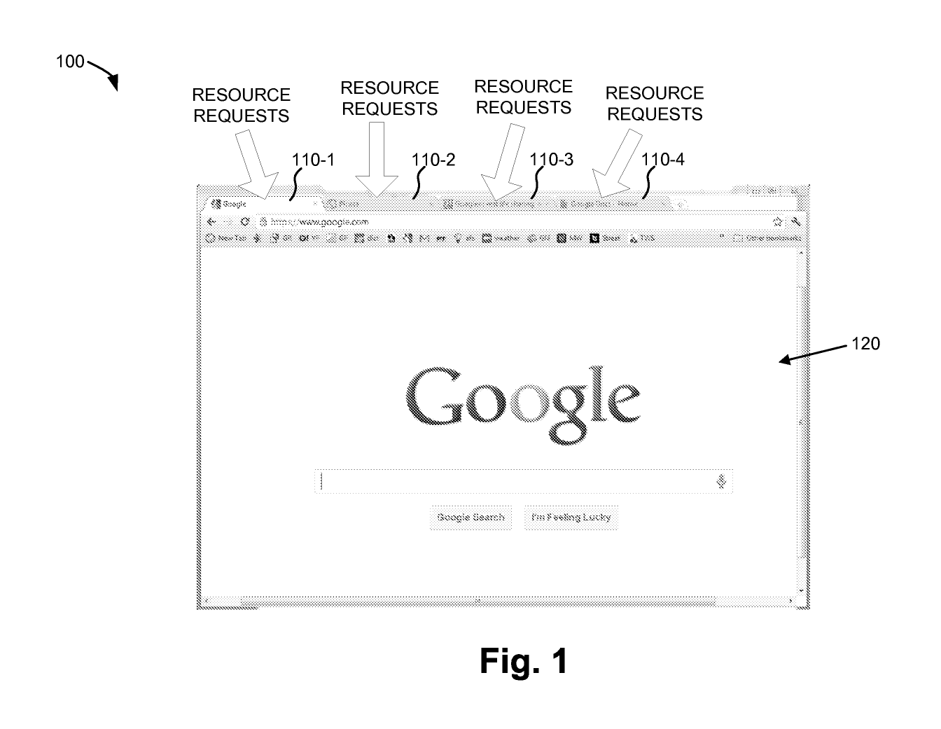

FIG. 1 is a diagram illustrating an example of an interface provided by a web browser 100. As shown, the user interface of browser 100 may include a number of tabs 110 (four tabs are particularly shown in FIG. 1 as tabs 110-1, 110-2, 110-3, and 110-4). Each of tabs 110 may be associated with a webpage. Tab 110-1 is illustrated as the active tab. The webpage associated with tab 110-1 may be provided to the user in window 120. The user may select, such as through a mouse click, a different one of tabs 110 to make the window of the selected tab the active window.

When browser 100 is started, browser 100 may attempt to restore all of the windows that were open when browser 100 was last closed. The windows of each of tabs 110 may be associated with a number of resource requests (illustrated as RESOURCE REQUESTS), to external network devices, that may need to be resolved before the window associated with a tab 110 can be fully rendered. Each resource request may refer to, for example, a request for an image, a script, a font definition, or other content that may be needed to fully render the webpage. The total number of resource requests, corresponding to the windows associated with all of tabs 110, that may need to be fulfilled when browser 100 is started, may be relatively large and may hence require significant time before all of the resource requests can be fulfilled.

Techniques described herein may schedule resource requests in a manner that provides a preference to resource requests that are associated with the foreground window (i.e. the window associated with the active tab), of browser 100. In order to limit the network load and/or processing load caused by browser 100, the quantity of concurrently pending resource requests may be limited. Resource requests may be selected for fulfillment in which a certain number of the pending resource requests are reserved for resource requests corresponding to the foreground window.

In one implementation, browser 100 may limit the number of concurrently pending resource queues on a per-website basis. For example, the concurrent number of pending resource requests, for each website and across all of the windows of tabs 110, may be limited to a first threshold, where the first threshold is an integer greater than one. Additionally, the concurrent number of pending resource requests, for each website and for all of the background windows (i.e., the non-visible or non-foreground windows) may be limited to a second threshold, where the second threshold is an integer greater less than the first threshold. Accordingly, there may always be at least some resource request slots (the first threshold minus the second threshold) that are reserved for resource requests corresponding to the foreground window.

In another possible implementation, resource requests associated with background (non-foreground) windows may be delayed or blocked for a particular period, such as for a predetermined time period or until a certain quantity or portion of resource requests associated with the foreground window have been fulfilled. By temporarily delaying/blocking resource requests associated with background windows, the resource requests associated with the foreground windows may be preferentially processed relative to the resource requests associated with the background windows. The information that the user currently desires, which may correspond to the information presented in the foreground window, may be more quickly presented to the user, thus potentially improving the user browsing experience.

### System Overview

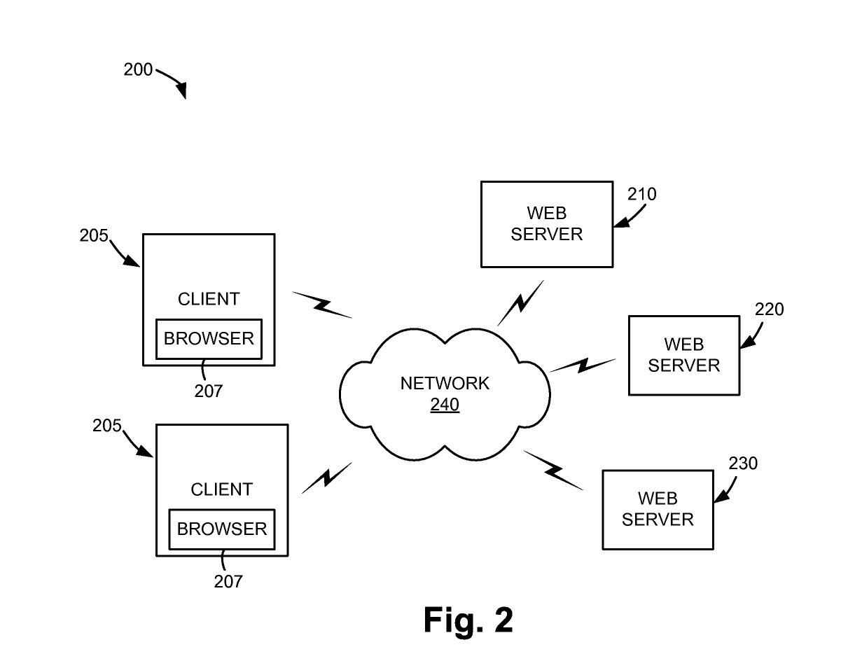

FIG. 2 is a diagram of an example environment 200 in which techniques described herein may be implemented. Environment 200 may include multiple clients 205 connected to one or more servers 210-230 via a network 240. In one implementation, and as illustrated, servers 210-230 may each include web servers. Clients 205 and servers 210-230 may connect to network 240 via wired connections, wireless connections, or a combination of wired and wireless connections.

Two clients 205 and three servers 210-240 are illustrated as connected to network 240 for simplicity. In practice, there may be additional or fewer clients and servers. Also, in some instances, a client may perform one or more functions of a server and a server may perform one or more functions of a client.

Clients 205 may include devices that can access servers 210-230. A client 205 may include, for instance, a personal computer, a wireless telephone, a personal digital assistant (PDA), a laptop, a smart phone, a tablet computer, or another type of computation or communication device. Client 205 may include a web browser 207.

Servers 210-230 may include devices that access, fetch, aggregate, process, search, provide, and/or maintain documents. As shown, servers 210 may include web servers that may provide content, such as webpages, to browsers 207 of clients 205. The webpages may be, for example, HTML-based webpages. A web server 210-230 may host one or more websites. A website, as the term is used herein, may refer to a collection of related webpages. Frequently, a website may be associated with a single domain, although some websites may potentially encompass more than one domain. In some implementations, a website may be synonymous with an IP host. Although shown as single components 210, 220, and 230, in FIG. 2, each server 210-230 may, in some implementations, be implemented as multiple computing devices, which potentially may be geographically distributed.

Network 240 may include one or more networks of any type, such as a local area network (LAN), a wide area network (WAN), a metropolitan area network (MAN), a telephone network, such as the Public Switched Telephone Network (PSTN) or a Public Land Mobile Network (PLMN), an intranet, the Internet, or a combination of networks.

Although FIG. 2 shows example components of environment 200, in other implementations, environment 200 may contain fewer components, different components, differently arranged components, or additional components than those depicted in FIG. 2. Alternatively, or additionally, one or more components of environment 200 may perform one or more other tasks described as being performed by one or more other components of environment 200.

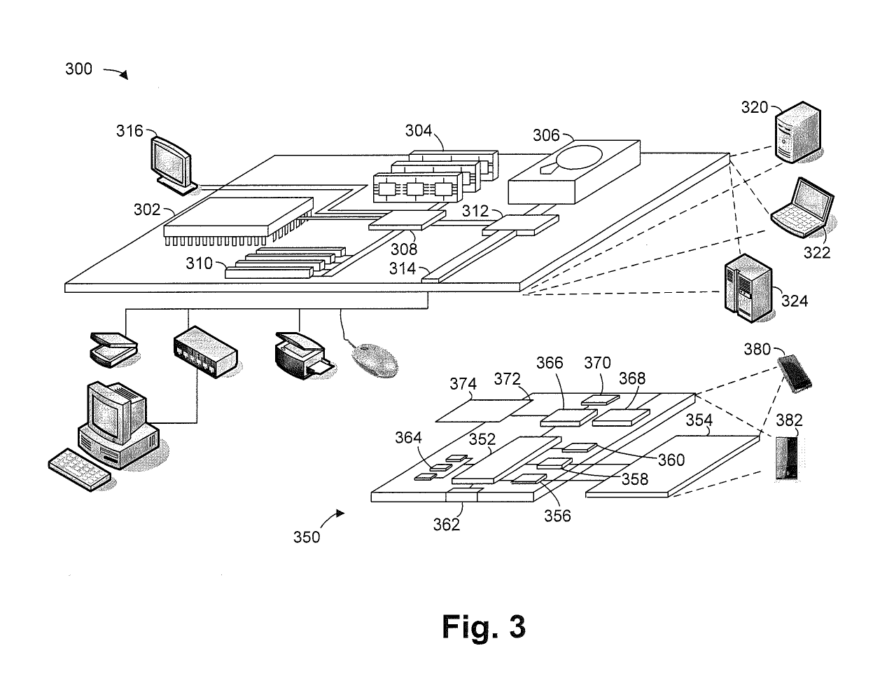

FIG. 3 is a diagram of an example of a generic computing device 300 and a generic mobile computing device 350, which may be used with the techniques described here. Generic computing device 300 or generic mobile computing device 350 may correspond to, for example, a client 205 and/or a server 210-230. Computing device 300 is intended to represent various forms of digital computers, such as laptops, desktops, workstations, personal digital assistants, servers, blade servers, mainframes, and other appropriate computers. Mobile computing device 350 is intended to represent various forms of mobile devices, such as personal digital assistants, cellular telephones, smart phones, tablet computers, and other similar computing devices. The components shown in FIG. 3, their connections and relationships, and their functions, are meant to be examples only, and are not meant to limit implementations described herein.

Computing device 300 may include a processor 302, a memory 304, a storage device 306, a high-speed interface 308 connecting to memory 304 and high-speed expansion ports 310, and a low-speed interface 312 connecting to a low-speed expansion port 314 and a storage device 306. Each of components 302, 304, 306, 308, 310, 312, and 314, are interconnected using various buses, and may be mounted on a common motherboard or in other manners as appropriate. Processor 302 can process instructions for execution within computing device 300, including instructions stored in memory 304 or on storage device 306 to display graphical information for a graphical user interface (GUI) on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations, as a server bank, a group of blade servers, or a multi-processor system, etc.

Memory 304 stores information within computing device 300. In one implementation, memory 304 includes a volatile memory unit or units. In another implementation, memory 304 may include a non-volatile memory unit or units. Memory 304 may also be another form of computer-readable medium, such as a magnetic or optical disk. A computer-readable medium may refer to a non-transitory memory device. A memory device may refer to storage space within a single storage device or spread across multiple storage devices.

Storage device 306 is capable of providing mass storage for computing device 300. In one implementation, storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or a memory on processor 302.

High-speed interface 308 manages bandwidth-intensive operations for computing device 300, while low-speed interface 312 manages lower bandwidth-intensive operations. Such allocation of functions is exemplary only. In one implementation, high-speed interface 308 is coupled to memory 304, display 316, such as through a graphics processor or accelerator, and to high-speed expansion ports 310, which may accept various expansion cards (not shown). In this implementation, low-speed interface 312 may be coupled to storage device 306 and low-speed expansion port 314. Low-speed expansion port 314, which may include various communication ports, such as a USB, Bluetooth, Ethernet, wireless Ethernet, etc., may be coupled to one or more input/output devices, such as a keyboard, a pointing device, a scanner, or a networking device such as a switch or router, e.g., through a network adapter.

Computing device 300 may be implemented in a number of different forms, as shown in the figure. For example, computing device 300 may be implemented as a standard server 320, or multiple times in a group of such servers. Computing device 300 may also be implemented as part of a rack server system 324. In addition, computing device 300 may be implemented in a personal computer, such as a laptop computer 322. Alternatively, components from computing device 300 may be combined with other components in a mobile device (not shown), such as mobile computing device 350. Each of such devices may contain one or more of computing devices 300, 350, and an entire system may be made up of multiple computing devices 300, 350 communicating with each other.

Mobile computing device 350 may include a processor 352, a memory 364, an input/output (“I/O”) device, such as a display 354, a communication interface 366, and a transceiver 368, among other components. Mobile computing device 350 may also be provided with a storage device, such as a micro-drive or other device, to provide additional storage. Each of the components 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a TFT LCD (Thin-Film-Transistor Liquid Crystal Display) or an OLED (Organic Light Emitting Diode) display, or other appropriate display technology. Display interface 356 may include appropriate circuitry for driving display 354 to present graphical and other information to a user. Control interface 358 may receive commands from a user and convert the commands for submission to processor 352. In addition, an external interface 362 may be provided in communication with processor 352, so as to enable near area communication of mobile computing device 350 with other devices. External interface 362 may provide, for example, for wired communication in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for device 350, or may also store applications or other information for mobile computing device 350. Specifically, expansion memory 374 may include instructions to carry out or supplement the processes described herein, and may include secure information also. Thus, for example, expansion memory 374 may be provided as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

Expansion memory 374 may include, for example, flash memory and/or NVRAM memory. In one implementation, a computer program product is tangibly embodied in an information carrier. The computer program product contains instructions that, when executed, perform one or more methods, such as those described above. The information carrier is a computer-or machine-readable medium, such as memory 364, expansion memory 374, or a memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 368. In addition, short-range communication may occur, such as using a Bluetooth, WiFi, or other such transceiver (not shown). In addition, GPS (Global Positioning System) receiver module 370 may provide additional navigation- and location-related wireless data to mobile computing device 350, which may be used as appropriate by applications running on mobile computing device 350.

Mobile computing device 350 may also communicate audibly using audio codec 360, which may receive spoken information from a user and convert the received spoken information to digital information. Audio codec 360 may likewise generate audible sound for a user, such as through a speaker, e.g., in a handset of mobile computing device 350. Such sound may include sound from voice telephone calls, may include recorded sound, such as voice messages, music files, etc., and may also include sound generated by applications operating on mobile computing device 350.

Mobile computing device 350 may be implemented in a number of different forms, as shown in the figure. For example, mobile computing device 350 may be implemented as a cellular telephone 380. Mobile computing device 350 may also be implemented as part of a smart phone 382, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device, such as a CRT (cathode ray tube) or LCD (liquid crystal display) monitor, for displaying information to the user and a keyboard and a pointing device by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The systems and techniques described herein can be implemented in a computing system that includes a back end component, such as a data server, or that includes a middleware component, such as an application server, or that includes a front end component, such as a client computer having a graphical user interface or a web browser through which a user can interact with an implementation of the systems and techniques described here, or any combination of such back end, middleware, or front end components. The components of the system can be interconnected by any form or medium of digital data communication. Examples of communication networks include a local area network (“LAN”), a wide area network (“WAN”), and the Internet.

### Browser Resource Request Scheduling

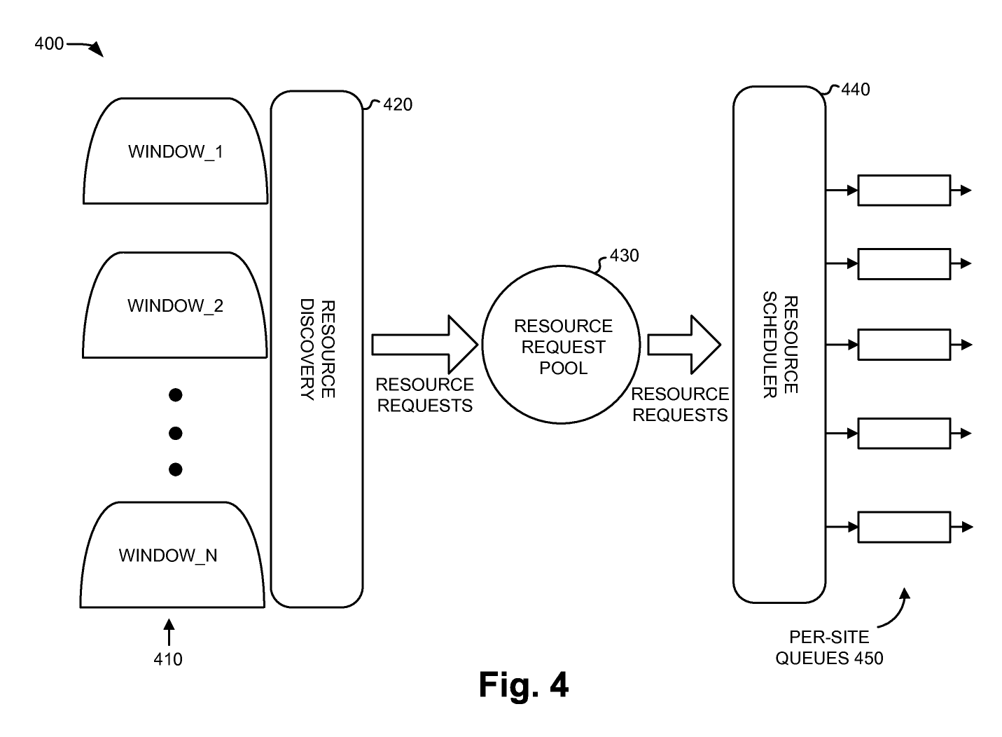

FIG. 4 is a diagram of example functional components 400 relating to the scheduling, by browser 207, of resource requests for fulfillment over network 240. Functional components 400 are illustrated as browser windows 410, a resource discovery component 420, a resource request pool 430, a resource scheduler 440, and per-site queues 450. Functional components 400 may be implemented by, for example, browser 207.

Browser windows 410 may correspond to tabs that are open in browser 207. A user may, for example, simultaneously keep multiple windows 410 open, where, in each window, a user may have navigated to a webpage of interest. The user may switch the active window 410 by, for example, using a pointer device, such as a mouse, to select a visible portion of the desired window 410, such as the visible tab portion of window 410. As used herein, a browser tab may be equivalently referred to as window, such as browser windows 410.

When browser 207 is started, browser 207 may attempt to restore the state of windows 410 (e.g., tabs) that were open when browser 207 was last closed. In one implementation, the URI or uniform resource locator (URL) of the webpages, that are associated with windows 410, may be saved when browser 207 is closed. When browser 207 is started, each of the saved URIs/URLs may be used to retrieve the webpage, such as an HTML document, associated with each window 410. Each webpage may include resource requests.

As an example of resource requests associated with a document, consider an HTML document that is retrieved in response to a web address, such as a URL entered by the user. The HTML document may include a number of links that require browser 207 to request additional information from external resources, such as web servers 210-230. Each of the links may correspond to a resource request. The resource requests may be, for example, requests relating to cascading stylesheets (CSSs), requests relating to fonts needed by the webpage, requests for images, requests relating to XML host requests (XMRs), requests for media objects, prefetch requests, prerender requests, and/or other types of resource requests. Prefetch and prerender requests may be requests relating to the downloading of a webpage before the webpage is actually requested by the user, such as a webpage that is determined to likely be accessed next by a user accessing a particular webpage.

Resource discovery component 420 may parse webpages, or other information, received by browser 207, to determine the resource requests that need to be made to render the webpages associated with windows 410. The discovery of resource requests may be an ongoing process in which additional resource requests may be discovered as previous resource requests are fulfilled. Discovered resource requests may be forwarded to resource request pool 430. In one implementation, each discovered resource request may be associated with the website that is to be contacted to fulfill the resource request. Additionally, each discovered resource request may be categorized based on whether the resource request corresponds to a requested resource that is needed to render a foreground window or a background window of browser 207.

Resource request pool 430 may store the discovered resource requests until the resource requests are scheduled for fulfillment by resource scheduler 440.

Resource scheduler 440 may select the resource requests, from resource request pool 430, and transmit the resource requests to the appropriate network entity for fulfillment of the resource request. The network entity for each resource request may correspond to, for example, a web server 210-230 or to any other network device that may be referenced by the resource request. In general, there may be numerous resource requests associated with a particular webpage. For example, certain webpages may require fulfilling tens or hundreds of resource requests before the webpage can be rendered. In order to avoid overwhelming client devices 205, or network resources, with network-related requests, resource scheduler 440 may impose limits on the number of resource requests that are being concurrently processed. For example, in one implementation, the number of simultaneous resource requests that are in-process, i.e., have been transmitted to a network entity, may be limited on a per-website basis. As previously mentioned, a website may refer to a collection of related webpages, such as one hosted by a web server 210-230 or one hosted by a number of web servers 210-230.

In general, resource scheduler 440 may select resource requests, stored in resource request pool 430, based on a first-in first-selected basis. In some implementations, resource scheduler 440 may additionally attempt to maximize the user experience with web browser 207 by prioritizing the selection of resource requests. For example, certain resource requests may need to be fulfilled before a webpage can begin to be rendered. These resource requests may include requests relating to the font used in a webpage, requests for the CSS of the webpage, or other requests relating to the basic layout or structure of the webpage. Other resource requests may be less important in terms of immediately rendering a webpage. For example, the substantive content of an image (or another media object) may not be initially needed when rendering the webpage, as the image may be downloaded and presented on the webpage after the initial text and structure of the webpage is presented to the user.

Per-site queues 450 may store, on a per-website basis, pending resource requests. Resource requests that are selected by resource scheduler 440 to be transmitted, to the network entity required by the resource request, may be transmitted and stored in per-site queues 450 until the response to the resource request is received back at client 205 or until the resource request is removed from a per-site queue 450 due to an error condition, such as a timeout error. In one implementation, per-site queues 450 may be limited to a certain size. For example, each per-site queue 450 may queue a maximum of a first threshold (e.g., 6, 10, or 20), where the first threshold is an integer, of resource requests. When one of per-site queues 450 is full, i.e., it contains the first threshold of pending resource requests, resource scheduler 440 may refrain from adding new resource requests to the per-site queue 450 until a pending resource requests is removed from the per-site queue 450. In this implementation, the number of resource requests that are simultaneously pending for a single website is thus limited to the first threshold.

Per-site queues 450, instead of being implemented on a per-website basis, may be implemented on another basis. For example, the queues may be implemented on a per-domain basis, on a sub-set of a domain or a website, or based on some other potential grouping of resource requests.

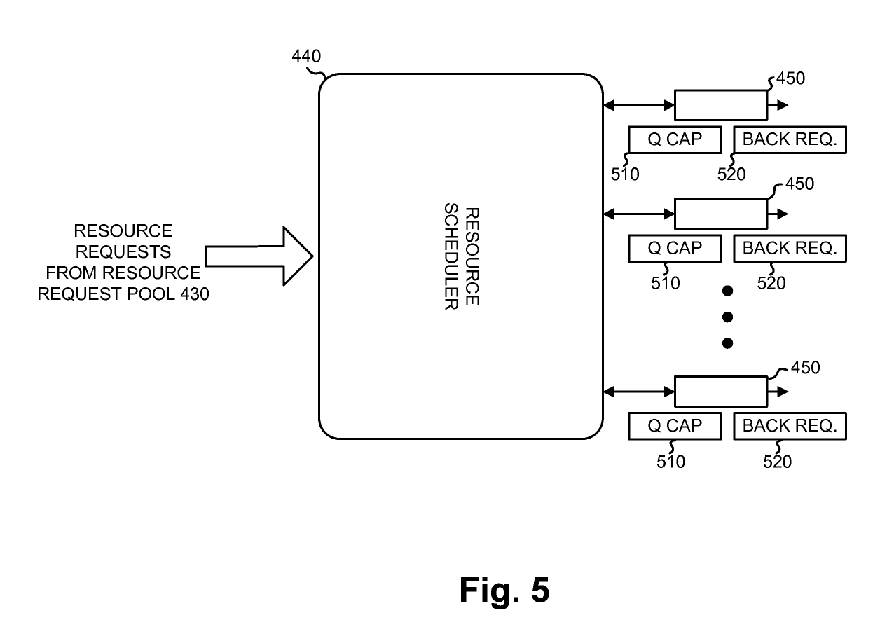

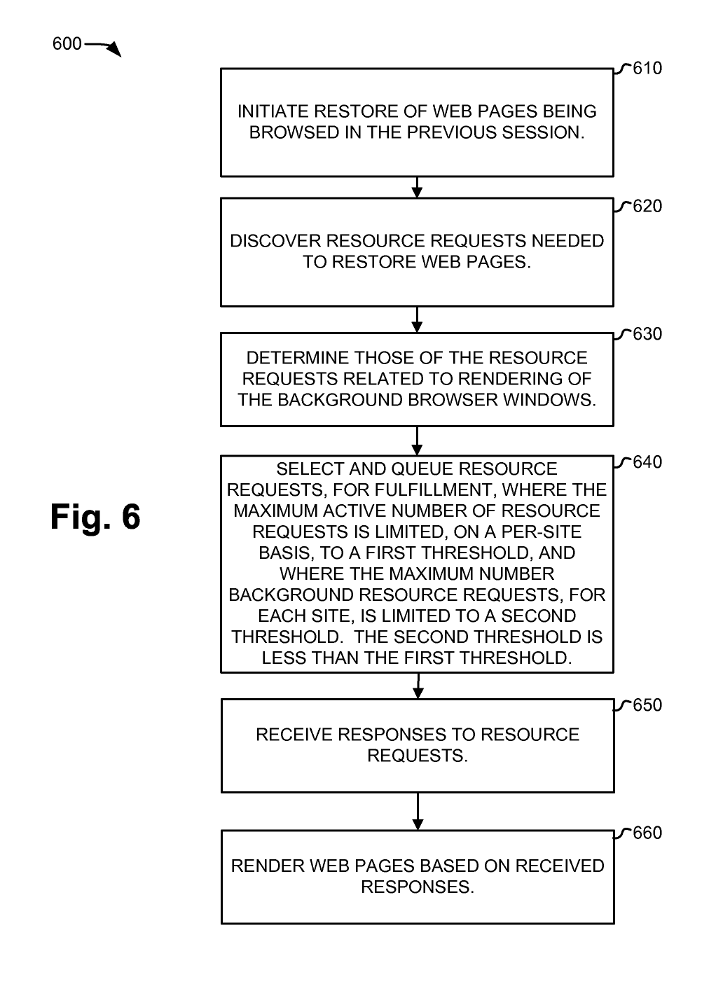

As will be described in more detail below, with reference to FIGS. 5 and 6, resource scheduler 440 may limit the number of resource requests queued in per-site queues 450 such that the number of stored resource requests, corresponding to background windows of browser 207, may be limited to a second threshold, where the second threshold is less than the maximum queue capacity, i.e., the first threshold. Resource scheduler 440 and per-site queues 450 will be described in more detail below, with reference to FIGS. 5 and 6.

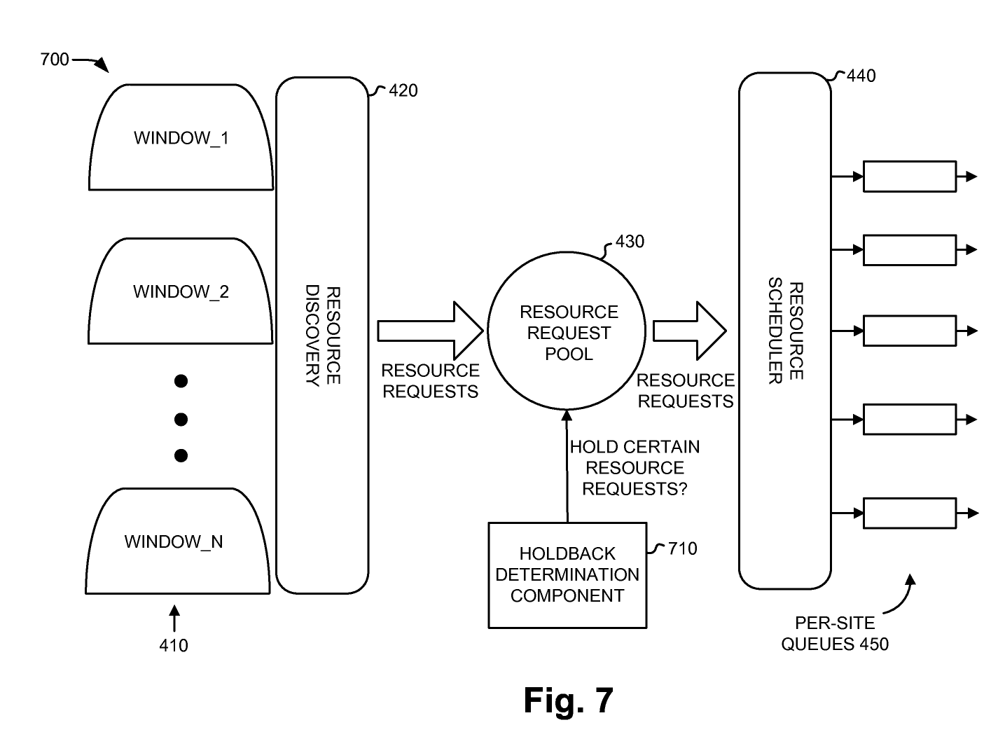

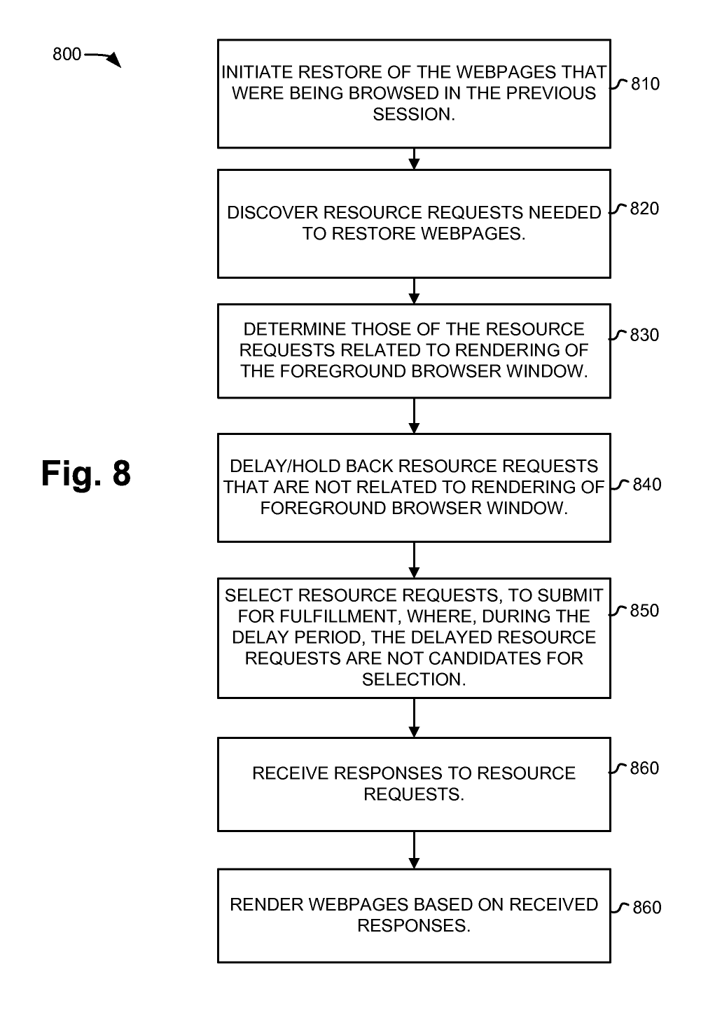

In an another possible implementation, as will be described with reference to FIGS. 7 and 8, resource requests that are not associated with a foreground window of browser 207 may be initially delayed or held back before being made a candidate for scheduling by resource scheduler 440.

Although FIG. 4 shows example functional components 400 of browser 207, in other implementations, browser 207 may contain fewer components, different components, differently arranged components, or additional components than those depicted in FIG. 4. Alternatively, or additionally, one or more components of browser 207 may perform one or more tasks described as being performed by one or more other components of browser 207.

FIG. 5 is a diagram of example functional components illustrating additional details of resource scheduler 440 and per-site queues 450. As shown, each per-site queue 450 may be associated with values, relating to the operation of the queue. As illustrated, each per-site queue 450 may be associated with: queue capacity (Q CAP) register 510 and background window request (BACK REQ) register 520.

Each queue capacity register 510 may store a count of the total quantity of resource requests that are currently pending for the website associated with the per-site queue 450. When a new resource request is selected by resource scheduler 440, from resource request pool 430, and submitted to network 240, the count of queue capacity register 510 may be incremented by one. When a response is received for a resource request, to fulfill the resource request, the resource request may be removed from per-site queue 450 and queue capacity register 510 may be decremented by one. Resource requests may be removed from per-site queues 450, and queue capacity register 510 decremented, for other reasons, such as if the resource request resulted in an error.

Although queue capacity registers 510 are shown as separate components in FIG. 5, in practice, queue capacity registers 510 may alternatively be implemented as part of per-site queues 450 and/or resource scheduler 440.

Background window request register 520 may store a count of the total number of resource requests that are currently pending for the website associated with the per-site queue 450 and that are associated with background windows. When a new resource request, that is associated with a background window, is selected by resource scheduler 440, from resource request pool 430, and submitted to network 240, the count of background window request register 520 may be incremented by one. When a response is received in response to a resource request that was associated with a background window, the resource request may be removed from per-site queue 450 and background window request register 520 may be decremented by one.

In one implementation, a background window may correspond to any of the non-active tabs of browser 207 and a foreground window may correspond to an active tab of browser 207. In some implementations, a user may be able to open multiple instances of browser 207, each of which may present an interface similar to that shown in FIG. 1, in which multiple tabs may be presented to the user. In this situation, each instance of browser 207 may include an active window and there may, therefore, be multiple foreground windows that are simultaneously open. In an alternative possible implementation, some portion of the active window may correspond to a background window. For example, an active window may include a visible section, which may be considered part of the foreground window, and a section, which may not be considered part of the foreground window, that is not visible to the user until the user performs a scroll operation. For example, a webpage may not fit vertically in the viewable interface of browser 207, and the user may need to perform a scroll operation to view the other portions of the webpage. At any particular time, the non-viewable portion of the webpage may be considered to be part of the background window. In general, a foreground window may refer to a portion of the graphical interface of browser 207 that is visible to the user and the background windows may refer to non-visible portions.

Although background window request registers 520 are shown as separate components in FIG. 5, in practice, background window request registers 520 may alternatively be implemented as part of per-site queues 450 and/or resource scheduler 440.

FIG. 6 is a flow chart illustrating an example process 600 for rendering webpages. Process 600 may be performed by a browser 207 of a client 205.

Process 600 may include initiating the restore of the webpages that were being browsed in a previous session of browser 207 (block 610). As previously discussed, browser 207 may provide webpages to a user in a number of windows. When browser 207 is closed, the URL of each tab may be stored. When browser 207 is subsequently restarted, browser 207 may attempt to restore, based on the stored URLs, the webpages that were provided in each of the tabs. For instance, browser 207 may request an HTML document referenced by each of the URLs. Process 600 may be performed on browser startup or at other times when a number of windows 410 are loading due to user action, such as when a user opens a number of windows 410 using mouse clicks (or keyboard actions) or when a user opens a number of windows 410 by opening a folder of bookmarks.

Process 600 may further include discovering resource requests needed to restore the webpages that were provided in the windows (block 620). The discovery of the resource requests may be based on the resource requests that are indicated by the HTML documents provided in the windows. For example, the HTML documents may be parsed to discover the resource requests.

Process 600 may further include determining the resource requests, of the discovered resource requests, associated with the background browser window or windows (block 630). A foreground window may generally refer to any portion of the interface of browser 207 that is visible to the user. In one implementation, all non-active windows may be considered to be background windows. Additionally, in some implementations, some portions of the foreground window may correspond to a non-foreground window. For example, as previously mentioned, a foreground window may include a visible section that is immediately visible to the user and a section that is not visible to the user until the user performs a scroll operation. The section that is not visible may be associated with the background browser window.

In some implementations, certain types of resource requests may be particularly important to initial webpage rendering. For example, font requests or CSS requests may not be counted against the background resource request limit for a per-site queue 450, even if the resource requests are actually part of a background window. Conversely, other types of resource requests may always be counted against the background resource request limit. For example, resource requests relating to images, media objects, XML host requests (XHRs), prefetch requests, and prerender requests, may always be counted against the background resource request limit, even if the resource request is actually part of a foreground window.

Process 600 may further include selecting resource requests, to submit for fulfillment, where the maximum total active number of resource requests is limited, on a per-website basis, to a first threshold, and where the maximum number of resource requests associated with background windows, on the per-website basis, is limited to a second threshold, where the second threshold is less than the first threshold (block 640). For example, in the context of FIG. 5, resource scheduler 440 may select resource requests for per-site queues 450 such that queue capacity registers 510 do not exceed the first threshold and background window request registers 520 do not exceed the second threshold. In this manner, for each per-site queue 450, a particular number of slots in the queue, equal to the first threshold minus the second threshold, will be guaranteed to be reserved for resource requests associated with foreground windows. Accordingly, when resource requests corresponding to a number of windows are being processed by browser 207, browser 270 may give preference to the resource requests associated with the active window, thus potentially increasing the responsiveness of the browser in rendering the display area that is visible to the user.

The selection of the resource requests may be based on, in addition to the counts relating to per-site queues 450, a number of possible scheduling techniques, such as a first-in first-scheduled technique or based on another scheduling technique. In some implementations, the scheduling may be performed by giving preference to certain types of resource requests. For example, resource requests that are determined to be important because the resource requests may be likely to be needed in the early stages of page rendering, such as a font or CSS, may be given preference over resource requests that are not likely or are less likely to impact the early stages of webpage rendering.

Process 600 may further include receiving responses to the resource requests that were scheduled and transmitted (block 650). Because the total number of simultaneous resource requests for a particular website may be limited, when a response to a resource request is received, another resource request may become eligible to be selected for fulfillment.

At some point, enough resource requests may have been fulfilled that the webpages being provided by browser 207 can be rendered and presented to the user (block 660). As previously mentioned, browser 207 may begin to render the webpage, corresponding to the active window, before all the resource requests corresponding to the active window have been fulfilled. Background windows may be similarly rendered based on the received resource requests, although background windows may not be visible until the user makes the background window the active window.

In the description of FIGS. 5 and 6, above, resource requests were scheduled using scheduling techniques that provide prioritized processing for resource requests associated with foreground windows, relative to resource requests associated with background windows, based on parameters associated with per-site queues 450.

An alternative technique for scheduling resource requests to provide prioritized processing for resource requests associated with foreground windows, will next be described with respect to FIGS. 7 and 8. The techniques described with respect to FIGS. 7 and 8 may be implemented in conjunction with the techniques described with respect to FIGS. 5 and 6, or as an alternative.

FIG. 7 is a diagram of example functional components 700, similar to that shown in FIG. 4, relating to the scheduling, by browser 207, of resource requests for fulfillment, according to a second implementation. As shown, in this implementation, a holdback determination component 710 may determine whether certain resource requests should be held back or delayed from the normal scheduling process implemented by resource scheduler 440.

Holdback determination component 710 may act to temporarily block or delay certain ones of the received resource requests. In one implementation, the resource requests that are delayed may include resource requests that are associated with background windows of browser 207. Holdback determination component 710 may be implemented, for example, as part of resource discovery component 420, resource scheduler 440, and/or resource request pool 430.

Holdback determination component 710 may delay the resource requests that are not related to rendering of the foreground window(s). In general, the resource requests may be delayed until the foreground window(s) in an early load state reach a state of later loading. Alternatively, in some implementations, certain resource requests that are associated with background windows, but that are determined to be resource requests that are generally important in rendering webpages, such as resource requests related to the overall structure of webpage (e.g., font related resource requests or CSSs), may not be delayed by delay component 710. Some resource requests, such as image requests, requests for media objects, XHR requests, prefetch requests, and prerender requests, may always be delayed by delay component 710.

Resource requests that are delayed by holdback determination component 710 may be delayed by a predetermined time period (e.g., 200 or 500 ms) or by a time period that is dynamically determined based on historical operation of browser 207. Alternatively or additionally, holdback determination component 710 may initially delay resource requests for the predetermined time period, but the time period may be adjusted based on performance of browser 207. For example, if resource scheduler 440 is frequently starved for resource requests, due to the resource requests being overly delayed, the delay time period may be dynamically reduced. As another example, the delay time period may be based on the number of resource requests that are in resource request pool 430. In some implementations, holdback determination component 710 may potentially delay different resource requests by different time periods. For example, some background resource requests may be delayed for one period and other, less important background resource requests, may be delayed for another (longer) period.

In some implementations, instead of delaying resource requests for a time period, holdback determination component 710 may delay certain resource requests until an event or condition is satisfied. For instance, holdback determination component 710 may hold back certain resource requests until a certain portion or quantity of initial resource requests have been initially queued and/or fulfilled. Alternatively, holdback determination component 710 may stop holding back resource requests based on different criteria, such as after all of a certain type or types of resource requests, such as all font or CSS related resource requests, have been scheduled by resource scheduler.

In one implementation, holdback determination component 710 may only operate to delay resource requests during an initial start up period of browser 207, or during another period, such as when a number of browser tabs 410 are simultaneously, or nearly simultaneously, opened. During this period, a significant number of resource requests, associated with each of the windows that are being restored, may tend to impede initial rendering of the active window by browser 207. In some implementations, after the initial start up period of browser 207, holdback determination component 710 may cease to delay the resource requests.

Although FIG. 7 illustrates functional components 700 relating to the scheduling of resource requests for fulfillment, in other implementations, fewer components, different components, differently arranged components, or additional components than those depicted in FIG. 7 may be used. FIG. 8 is a flow chart illustrating an example process 800 for rendering webpages. Process 800 may be performed by a browser 207 of a client 205.

Process 800 may include initiating the restore of the webpages that were opened in a previous session of browser 207 (block 810). As previously discussed, browser 207 may provide webpages to a user in a number of windows. When browser 207 is closed, the URL of each window may be stored. When browser 207 is subsequently restarted, browser 207 may attempt to restore, based on the stored URLs, the webpages that were provided in each of the windows. For instance, browser 207 may request an HTML document referenced by each of the URLs. Process 900 may be performed on browser startup or at other times when a number of windows 410 are loading due to user action, such as when a user opens a number of windows 410 using mouse clicks (or keyboard actions) or when a user opens a number of windows 410 by opening a folder of bookmarks.

Process 800 may further include discovering resource requests needed to restore the webpages that were provided in the windows (block 820). The discovery of the resource requests may be based on the resource requests that are indicated by the HTML documents provided in the windows. For example, the HTML documents may be parsed to discover the resource requests.

Process 800 may further include determining the resource requests, of the discovered resource requests, related to rendering of the foreground browser window (block 830). A foreground window may generally refer to any portion of the interface of browser 207 that is visible to the user. In one implementation, all non-active windows may be considered to be background windows (i.e., non-foreground windows). Additionally, in some implementations, some portions of the foreground window may correspond to a non-foreground window. For example, as previously mentioned, a foreground window may include a visible section that is immediately visible to the user and a section that is not visible to the user until the user performs a scroll operation. The section that is not visible may be associated with the background browser window.

Process 800 may further include delaying and/or holding back resource requests that are not related to the rendering of the foreground browser window (block 840). The resource requests that are to be delayed may be delayed for a particular time period, such as a predetermined time period, or by a time period that is dynamically determined based on operation of browser 207. Alternatively, the particular delay period may be an indeterminate period in which the end of the delay period is determined based on an event or the satisfaction of certain criteria, such as when the scheduler has processed a certain quantity of resource requests, a certain portion of the outstanding resource requests, or based on other criteria. In some implementations, certain resource requests, such as XHR requests, prefetch requests, and prerender requests, may always be delayed even they are in a foreground window. In some implementations, certain resource requests, such as font or CSS requests, may never be delayed, even if they are in a background window.

Process 800 may further include selecting resource requests, to submit for fulfillment, where, during the period in which the resource requests are delayed, the delayed resource requests are not candidates for selection (block 850). The selection of the resource requests may be performed using a number of possible scheduling techniques, such as a first-in first selected scheduling technique or based on another scheduling technique. In some implementations, the scheduling may be performed by giving preference to certain types of resource requests. For example, resource requests that are determined to be important because the resource requests may be likely to be needed in the early stages of page rendering, may be given preference over resource requests that are not likely or are less likely to impact the early stages of webpage rendering.

Process 800 may further include receiving responses to the resource requests that were scheduled and transmitted (block 860). In one implementation, the total number of simultaneous resource requests or the number of simultaneous resource requests for a particular website may be limited. When a response to a resource request is received, another resource request may therefore be eligible to be selected for fulfillment.

At some point, enough resource requests may have been fulfilled that the webpages being provided by browser 207 can be rendered and presented to the user (block 870). As previously mentioned, browser 207 may begin to present the webpage, corresponding to the foreground window, before all the resource requests corresponding to the foreground window have been fulfilled. Background windows may be similarly rendered based on the received resource requests, although background windows may not be visible until the user makes the background window the active window.

While a series of blocks have been described with regard to FIGS. 6 and 8, the order of the blocks may be modified in other implementations. Further, non-dependent blocks may be performed in parallel. In addition, other blocks may be provided, or blocks may be eliminated, from the described flowchart, and other components may be added to, or removed from, the described systems.

The foregoing description provides illustration and description, but is not intended to be exhaustive or to limit the embodiments to the precise form disclosed. Modifications and variations are possible in light of the above teachings or may be acquired from practice of these embodiments.

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

It should be emphasized that the term “comprises/comprising,” when used in this specification, is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the implementation includes each dependent claim in combination with every other claim in the claim set.

No element, act, or instruction used in the present application should be construed as critical or essential to the disclosed embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method, performed by one or more devices, the method comprising:
receiving, by the one or more devices, resource requests, associated with one or more webpages, that are to be rendered by a single web browser application executed by the one or more devices,
where the web browser application includes a foreground window and at least one background window,
the foreground window being associated with a first resource request, of the resource requests, associated with a first webpage of the one or more webpages, and
the at least one background window being associated with a second resource request, of the resource requests, associated with one or more second webpages of the one or more webpages;
determining, by the one or more devices, a set of the resource requests that are associated with the at least one background window,
the set of resource requests including the second resource request;
selecting, by the one or more devices, the resource requests, the selecting including:
limiting a first quantity of selected resource requests, associated with the foreground window and the at least one background window, to a first threshold, and
limiting a second quantity of selected resource requests, that are determined to be in the set of resource requests associated with the at least one background window, to a second threshold,
where the second threshold is less than the first threshold;
transmitting, by the one or more devices, the selected resource requests for fulfillment;
receiving, by the one or more devices, responses to the transmitted resource requests; and
rendering, by the one or more devices, at least one of the one or more webpages based on the received responses.

2. The method of claim 1, where the first quantity of selected resource requests represent a total quantity of resource requests that are permitted to be simultaneously active.

3. The method of claim 1, where
the first quantity of selected resource requests are associated with a particular website, and
the second quantity of selected resource requests include resource requests that are associated with the particular website and that are determined to be in the set of resource requests associated with the at least one background window.

4. The method of claim 1, further comprising:
classifying resource requests that are not important to initial rendering of visible areas of a graphical interface of the web browser application as resource requests that are effectively associated with the at least one background window.

5. The method of claim 1, further comprising:
providing, by the web browser application executed by the one or more devices and for presentation, the one or more webpages in corresponding tabbed windows,
where the tabbed windows includes the foreground window and the at least one background window.

6. The method of claim 1, further comprising:
excluding, from the second quantity of selected resource requests, resource requests relating to cascading style sheet (CSS) requests.

7. The method of claim 1, further comprising:
including, in the second quantity of selected resource requests, all resource requests relating to images and media objects.

8. The method of claim 1, further comprising:
including, in the second quantity of selected resource requests, all resource requests relating to XML host requests.

9. The method of claim 1, further comprising:
including, in the second quantity of selected resource requests, all resource requests relating to prefetch requests and prerender requests.

10. The method of claim 1, where receiving the resource requests further includes:
receiving hypertext markup language (HTML) documents; and
parsing the HTML documents to obtain the resource requests.

11. The method of claim 1, further comprising:
determining the set of the resource requests that are associated with the at least one background window to include resource requests that are in the foreground window but are not in a viewable area of the foreground window.

12. The method of claim 1, further comprising:
holding back, for a particular period, and from the selection of the resource requests, the set of the resource requests that are associated with the at least one background window.

13. One or more computing devices comprising:
one or more memories to store instructions; and
one or more processors, to execute the instructions, to:
receive resource requests, associated with one or more webpages, that are to be rendered by a single web browser application executed by the one or more processors,
where the web browser application includes a foreground window and at least one background window,
the foreground window being associated with a first resource request, of the resource requests, associated with a first webpage of the one or more webpages, and
the at least one background window being associated with a second resource request, of the resource requests, associated with one or more second webpages of the one or more webpages;
determine a set of the resource requests that are associated with the at least one background window,
the set of resource requests including the second resource request;
select the resource requests,
the one or more processors, when selecting the resource requests, being to:
limit a first quantity of selected resource requests, associated with the foreground window or the at least one background window, to a first threshold, and
limit a second quantity of selected resource requests, that are determined to be in the set of resource requests associated with the at least one background window, to a second threshold,
where the second threshold is less than the first threshold;
transmit the selected resource requests for fulfillment;
receive responses to the transmitted resource requests; and
render at least one of the one or more webpages based on the received responses.

14. The one or more computing devices of claim 13, where the first quantity of selected resource requests represent a total quantity of resource requests that are permitted to be simultaneously active.

15. The one or more computing devices of claim 13, where
the first quantity of selected resource requests are associated with a particular website, and
the second quantity of selected resource requests include resource requests that are associated with the particular website and that are determined to be in the set of resource requests associated with the at least one background window.

16. The one or more computing devices of claim 13, where the one or more processors further execute instructions to:
classify resource requests that are not important to initial rendering of visible areas of a graphical interface of the web browser application as resource requests that are effectively associated with the at least one background window.

17. The one or more computing devices of claim 13, where the one or more processors further execute instructions to:
provide, by the web browser application and for presentation, the one or more webpages in corresponding tabbed windows,
where the tabbed windows include the foreground window and the at least one background window.

18. The one or more computing devices of claim 13, where the one or more processors further execute instructions to:
exclude, from the second quantity of selected resource requests, all resource requests relating to cascading style sheet (CSS) requests.

19. The one or more computing devices of claim 13, where the one or more processors further execute instructions to:
include, in the second quantity of selected resource requests, all resource requests relating to images and media objects.

20. The one or more computing devices of claim 13, where the one or more processors further execute instructions to:
include, in the second quantity of selected resource requests, all resource requests relating to XML host requests (XHRs).

21. The one or more computing devices of claim 13, where the one or more processors further execute instructions to:
include, in the second quantity of selected resource requests, all resource requests relating to prefetch requests and prerender requests.

22. The one or more computing devices of claim 13, where the one or more processors further execute instructions to:
receive hypertext markup language (HTML) documents; and
parse the HTML documents to obtain the resource requests.

23. The one or more computing devices of claim 13, where the one or more processors further execute instructions to:
determine the resource requests that are associated with the at least one background window as those of the resource requests that are not important to initial rendering of visible areas of a graphical interface of the web browser application.

24. A non-transitory computer-readable medium storing instructions, the instructions comprising:
one or more instructions, which when executed by one or more processors, cause the one or more processors to receive resource requests, associated with one or more webpages, that are to be rendered by a single web browser application executed by the one or more processors, where
each of the resource requests are additionally associated with a website, and the web browser application includes a foreground window and at least one background window,
the foreground window being associated with a first resource request, of the resource requests, associated with a first webpage of the one or more webpages, and
the at least one background window being associated with a second resource request, of the resource requests, associated with one or more second webpages of the one or more webpages;
one or more instructions, which when executed by the one or more processors, cause the one or more processors to determine a set of the resource requests that are associated with the at least one background window,
the set of resource requests including the second resource request;
one or more instructions, which when executed by the one or more processors, cause the one or more processors to select the resource requests,
the one or more instructions to select the resource requests including:
one or more instructions, which when executed by the one or more processors, cause the one or more processors to limit a quantity of selected resource requests, associated with the foreground window or the at least one background window and associated with a particular website, to a first threshold, and
one or more instructions, which when executed by the one or more processors, cause the one or more processors to limit a quantity of selected resource requests, that are associated with the particular website and that are determined to be in the set of resource requests associated with the at least one background window, to a second threshold,
where the second threshold is less than the first threshold;
one or more instructions, which when executed by the one or more processors, cause the one or more processors to transmit the selected resource requests for fulfillment;
one or more instructions, which when executed by the one or more processors, cause the one or more processors to receive responses to the transmitted resource requests; and
one or more instructions, which when executed by the one or more processors, cause the one or more processors to render at least one of the one or more webpages based on the received responses.

25. The non-transitory computer-readable medium of claim 24, the instructions further comprising:
one or more instructions, which when executed by the one or more processors, cause the one or more processors to determine the resource requests that are associated with the at least one background window as those of the resource requests that are not important to initial rendering of visible areas of a graphical interface of the web browser application.

26. The non-transitory computer-readable medium of claim 24, the instructions further comprising:
one or more instructions, which when executed by the one or more processors, cause the one or more processors to hold back, for a particular period and from the selection of the resource requests, the set of the resource requests that are associated with the at least one background window.

27-49. (canceled)
